(19) United States
(12) Patent Application Publication
(10) Pub. No.: US 2003/0126601 A1
(43) Pub. Date: Jul. 3, 2003

(54) Visualization of entertainment content

(75) Inventors: Guy Roberts, Eindhoven (NL); Jacquelyn Martino, Cold Springs, NY (US); Jeanne DeBont, Maarheeze (NL); Lira Nikolovska, Amsterdam (NL); John Zimmerman, Ossining, NY (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V., Eindhoven (NL)

(21) Appl. No.: 10/038,874

(22) Filed: Dec. 31, 2001

(51) Int. Cl. H04N 7/025; H04N 7/10; G06F 3/00; G06F 13/00; H04N 5/445; H04N 7/16; G09G 5/00

(52) U.S. Cl. 725/37; 725/53; 348/563; 725/135; 345/705; 725/34

(57) ABSTRACT

Search results in a personalized system or a search system are graphically represented by elements having a graphical feature such as size or proximity to the viewer dependent upon a relevance of the represented item(s) to the search criteria. All available items searched are preferably displayed regardless of whether matching the search criteria (with matches distinguished from non-matches), providing the user with context for items determined to have some degree of relevance to the specified criteria. The graphical elements are updated with condition changes such as changes to search query elements or changes to the pool of items available to be searched. Similar or related results may be linked.

### CROSS-REFERENCE TO RELATED APPLICATIONS

The present invention is related to those disclosed in the following United States Non-Provisional Patent Applications:

1) Ser. No. ______ [Docket No. US010683] filed concurrently herewith, entitled “METHOD OF POPULATING AN EXPLICIT PROFILE”;

2) Ser. No. ______ [Docket No. US010684] filed concurrently herewith, entitled “METHOD AND APPARATUS FOR ACCESS AND DISPLAY OF CONTENT ALLOWING USERS TO APPLY MULTIPLE PROFILES”;

3) Ser. No. ______ [Docket No. US010685] filed concurrently herewith, entitled “SORT SLIDER WITH CONTEXT INTUITIVE SORT KEYS”.

The above applications are commonly assigned to the assignee of the present invention. The disclosures of these related patent applications are hereby incorporated by reference for all purposes as if fully set forth herein.

### TECHNICAL FIELD OF THE INVENTION

The present invention is directed, in general, to search systems and, more specifically, to presentation of search results in a graphical environment.

### BACKGROUND OF THE INVENTION

Current embodiments of search systems typically utilize ordered lists to represent the found content. For example, a search system utilizing a recommender will often place the most relevant information within the search results at the top of the list. However, since the results are often much larger than can be listed in a single user interface display, the user often has no sense of how large the total set of results are or how the results displayed relate to the current search or sorting criteria.

Additionally, search results from current systems are generally not dynamic, but require that the search be re-run whenever the search criteria or field of search changes in order to obtain accurate results. For this reason, the user is often unable to immediately see how changing search criteria affects the results.

There is, therefore, a need in the art for offering a gestalt view of search results depicting large amounts of data in a confined visual field with dynamic updates.

### SUMMARY OF THE INVENTION

To address the above-discussed deficiencies of the prior art, it is a primary object of the present invention to provide, for use in a content reception system, a presentation technique for search results in a personalized system or a search system. Search results are graphically represented in two or three dimensions with each axis representing an attribute of the entire set of search results. Proximity to the viewer, for example, may indicate the rating of a piece of content based on a user profile. The graphical elements are updated with condition changes such as changes to search query elements or changes to the pool of items available to be searched. Similar or related results may be linked.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a content reception system employing a search result presentation mechanism according to one embodiment of the present invention;

FIG. 2 is a mockup of a user interface display for a content reception system controller employing a search result presentation mechanism according to one embodiment of the present invention; and

FIG. 3 is a high level flowchart for a process of presenting data in a manner facilitating global visualization according to one embodiment of the present invention.

### DETAILED DESCRIPTION OF THE INVENTION

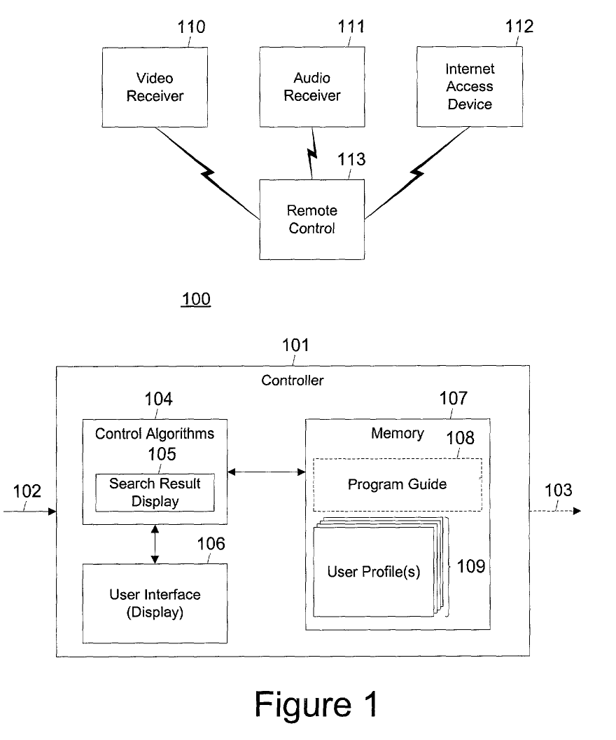

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a content reception system employing a search result presentation mechanism according to one embodiment of the present invention. Within a content reception system 100, a controller 101 receives at least information regarding content available from one or more external sources (not shown) such as a broadcasting facility or a broadcast or Internet content server, as well as optionally the associated content. Accordingly, controller 101 may be implemented within a video receiver 110 such as a television, a satellite, terrestrial, or cable broadcast decoder unit, a digital video recorder, within an audio receiver 111 such as a terrestrial or satellite radio receiver or a compact disc or digital audio player, or within an Internet access device 112 such as a set-top box, a personal computer or the like. Additionally, controller 101 may be implemented within a remote control device 113 adapted for controlling the operation of one or more of the video receiver 110, the audio receiver 111, and the Internet access device 112, and optionally including an integral display and the like. Controller 101 may also be implemented in a distributed fashion, with various portions being disposed within two or more devices forming the video receiver 110, the audio receiver 111, the Internet access device 112, and the remote control 113.

However implemented, content reception system controller 101 includes an input 102 for receiving at least the information regarding content available from the one or more external sources and optionally an output 103 for transmitting content, control signals, and/or user interface data to a receiver, display or recording device.

Those skilled in the art will recognize that the full construction and operation of a content reception system controller is not depicted or described herein. Instead, for simplicity and clarity, only so much of the construction and operation of a content reception system controller as is unique to the present invention or necessary for and understanding of the present invention is depicted and described. The remainder of the construction and operation of the controller may follow conventional practices known in the art. Moreover, although a video receiver, an audio receiver, an Internet access device, and a remote control are employed in the exemplary embodiment, those skilled in the art will recognize that the functionality described herein may be readily adapted to other types of devices such as, for example, game devices, and thereby employed with other forms of content.

In the exemplary embodiment, controller 101 includes a control algorithms or programmable logic circuits 104 including a search result display module or functionality 105. A user interface 106 communicably coupled to the controller 104 enables user input from, for example, an infrared remote control, a touch screen, or input buttons. User interface 106 may include a display or, alternatively, content reception system controller 101 may be coupled to a separate display device. Controller 101 in the exemplary embodiment also includes a memory 107, preferably nonvolatile. Memory 107 is employed to optionally store received information 108 about available content (e.g., a program guide) and to store one or more user profiles 109. User profiles 109 in the example shown are explicit profiles of user preferences having, associated with each item or attribute, an item type and a user rating value for the respective item, which may include express user ratings as well as collected historical viewing information. Other forms of user profiles may alternatively be employed. Display controller 105 and user profiles 109 may, of course, be located on a remote system from controller 101 and transmit display data to controller 101.

In the exemplary embodiment, controller 101 employs attributes within each item of information 108 regarding content (that is, program guide items) and rating values for such attributes within a currently selected user profile 109 to generate content suggestions. In the present invention, the results are presented in a manner promoting global visualization of the results as described in further detail below. Moreover, those skilled in the art will recognize that while the exemplary embodiment relates to a recommender system, the present invention may be employed with any data processing system employing a search result display mechanism.

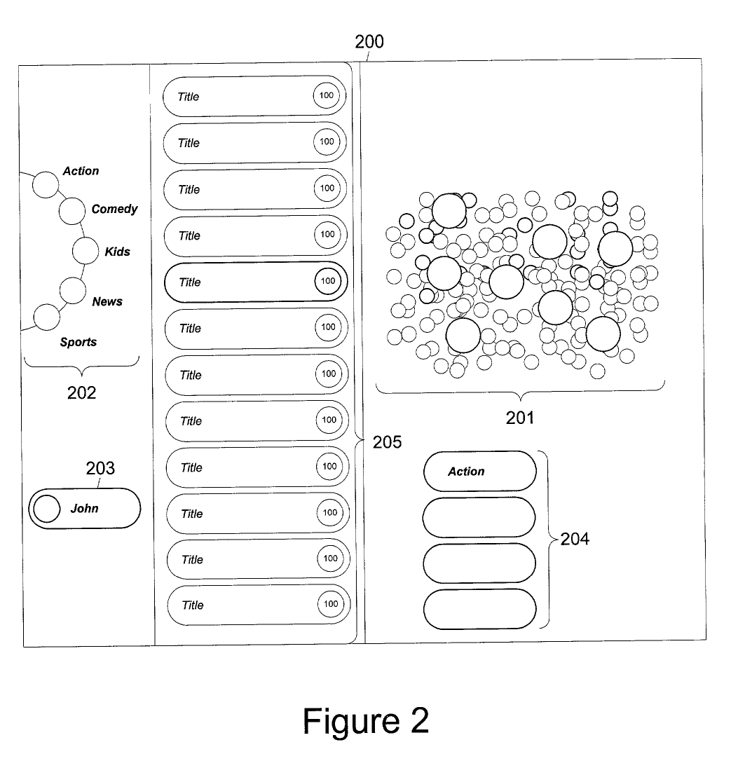

FIG. 2 is a mockup of a user interface display for a content reception system controller employing a search result presentation mechanism according to one embodiment of the present invention. The user interface depicted is employed, for example, by controller 101 depicted in FIG. 1. With fields of search such as currently available video programming, as in the exemplary embodiment, large amounts of data may be generated as the results of a particular search. In fact, when simply searching available video programming across several hundred broadcast channels for content which will be most relevant to (that is, most likely to be enjoyed by) a user within a personalized system, the results can include the entire spectrum of available video programming, with some results obviously having substantially higher rankings than others. In the present invention, this display problem is addressed by presentation of results in a manner facilitating global visualization of the content.

Within user interface display 200 in FIG. 2, search results 201 are displayed with each available item of content within the currently available pool of content represented by a graphical element. In the example shown, each item of content is represented by a sphere having attributes such as texture/pattern, color, size, movement and position dependent on a different attribute of the item represented. For instance, color or pattern may indicate the type or genre of the program (e.g., sports, talk show, news, etc.). Relevancy of a particular item of content to an active user profile (that is, how high the recommendation is for the respective program) is also indicated graphically within user interface display 200, in the example shown by the size of the graphical element representing the content item (i.e., more relevant items have a larger size). In the example shown, a simplistic presentation of results as either matching or non-matching is displayed, although numerous other levels of gradation (i.e., varying sizes of spheres) may also be employed. Other graphical techniques of indicating relevance may be employed, such as locating graphical elements for more relevant content closer to the viewer in a three dimensional user interface display.

Search options 202 and the active profile 203 employed in making the recommendations represented by results 201 are also displayed in user interface display 200, together with an indication of the currently selected search criteria 204. A scrollable results list 205 of only matching content is also displayed, sorting by rating, title, or some other sort key or combination of sort keys.

Changes to the search criteria 204 will change the results list 205 (including the number of results) and the presentation of results within the search pool graphic 201 (i.e., different items may be larger) without changing the number of items represented by the graphic 201. Similarly, changes to the active profile 203 employed in generating the recommendations will not change the number of items represented within graphic 201, but will change the presentation of some items. Preferably the entire search field is graphically represented within the user interface display, including items which do not match or have no relevancy to the active user profile. Matches may be distinguished, for example, by highlighting the graphical objects representing the matching programs. By displaying representations of the entire search field, however, the user is given a global sense of how the matching search results relate to the entire body of available content.

The graphic representations of content are dynamic, able to update in real-time to changing conditions such as changes to the search query formulation or addition or subtraction of items from the field of search, or the database or pool of information being searched. The former may occur within a recommender system when a different user profile is selected as the active profile, while the later may occur when available programming ceases being available and is replaced by different content (e.g., at hourly or half-hourly program changes).

In the exemplary embodiment, the user can see how many action shows are present within the entire search pool, and what portion of the search pool comprises action shows. By changing the search criteria to comedy and getting a dynamic update to graphic 201, the user can immediately see how many comedies there are within the search pool and how many there are in relation to the number of action programs.

In the example shown, more highly recommended programs are larger and/or closer to the viewer, so that the number of smaller objects provides the user with a global view of how much content is relevant to their preferences. The vertical and horizontal axes may show other information, such as title (alphabetic ordering), time of day, channel, or any other attribute.

Dynamic updates to the graphical representations of content may be implicitly prompted as well as explicitly prompted by changing conditions. For instance, a system employing historical viewing data to, at least in part, define a user's preferences may update representations of content as the system learns more about the current user (e.g., a viewing selection by the user occurs).

An advantage achieved by presentation of large amounts of data in a manner facilitating global visualization of the data is that the user can see the relevant content located by a query (or current user profile) in relation to all other available content. This affords the user a better understanding of how a personalized system is functioning on their behalf, and helps them modify the system to achieve improved results. Additionally, the user can preferably interact with the pieces of relevant content represented within the user interface display, selecting a representation of content for use as a basis in a new query (or modification of the current user profile), where the item of content acts as a noun in a noun-verb graphical interface model.

The presentation of data according to the present invention visualizes all of the choices available to a user. In the case of a specific query formulation via a user interface, the visualization preferably highlights (or otherwise graphically distinguishes) all items matching the currently active query. When the query formulation tool is collapsed or out of view, the global visualization preferably highlights only the single active item within the query results list.

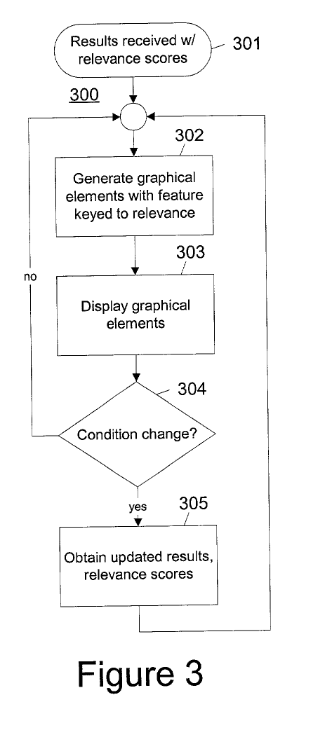

FIG. 3 is a high level flowchart for a process of presenting data in a manner facilitating global visualization according to one embodiment of the present invention. The process 300 begins with receipt of results with associated relevance scores (step 301). Graphical elements representative of each result are generated with a feature (e.g., size or proximity to viewer) keyed to the relevance scores (step 302) and the graphical elements are displayed (step 303).

If a condition change occurs (step 304) such as an alteration to the underlying query or user profile or a change in the pool of information searched, updated results and relevance scores are obtained (step 305) and new graphical elements representing the results are generated (step 302). The process continues until interrupted by the user clearing the display and/or selecting other functionality.

The present invention provides a mechanism for presenting large amounts of data such as search results within a confined viewing area in a manner facilitating global visualization of the data by the viewer, with relevance graphically communicated and results dynamically updated as necessary.

It is important to note that while the present invention has been described in the context of a fully functional system, those skilled in the art will appreciate that at least portions of the mechanism of the present invention are capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A display system comprising:
a display controller generating a plurality of graphical elements representative of each available item within a search pool,
a graphical feature of each graphical element depending upon a relevance of the associated item to specified criteria,
wherein the graphical element is updated in response to any change to the specified criteria or the search pool.

2. The display system according to claim 1, wherein the graphical feature of each graphical element depending upon the relevance of the associated item to specified criteria further comprises one of a size of the graphical element or a perceived proximity of the graphical element to a viewer.

3. The display system according to claim 1, wherein one or more graphical elements are representative of multiple items within the search pool and serving as a user control triggering expanded display of additional graphical elements each representative of a subset of the multiple items.

4. The display system according to claim 1, wherein the graphical element is updated whenever the specified criteria are changed by either adding, deleting or modifying a search query element or updating a user profile.

5. The display system according to claim 1, wherein the graphical element is updated whenever an item is added or deleted from the search pool.

6. A content reception system comprising:
a input receiving content and information items regarding the content, wherein the information items form a search pool; and
a display controller receiving search results from a search on the search pool and generating a plurality of graphical elements representative of each available item within a search pool,
a graphical feature of each graphical element depending upon a relevance of the associated item to specified criteria,
wherein the graphical element is updated in response to any change to the specified criteria or the search pool.

7. The content reception system according to claim 6, wherein the graphical feature of each graphical element depending upon the relevance of the associated item to specified criteria further comprises one of a size of the graphical element or a perceived proximity of the graphical element to a viewer.

8. The content reception system according to claim 6, wherein one or more graphical elements are representative of multiple items within the search pool and serving as a user control triggering expanded display of additional graphical elements each representative of a subset of the multiple items.

9. The content reception system according to claim 6, wherein the graphical element is updated whenever the specified criteria are changed by either adding; deleting or modifying a search query element or updating a user profile.

10. The content reception system according to claim 6, wherein the graphical element is updated whenever an item is added or deleted from the search pool.

11. A content search and result display method comprising:
receiving content and information items regarding the content, wherein the information items form a search pool;
searching the search pool utilizing specified criteria to produce a relevance of each information item to the specified criteria; and
generating a plurality of graphical elements representative of each available item within a search pool,
wherein a graphical feature of each graphical element depends upon a relevance of the associated item to specified criteria, and
wherein the graphical element is updated in response to any change to the specified criteria or the search pool.

12. The method according to claim 11, wherein the graphical feature of each graphical element depending upon the relevance of the associated item to specified criteria further comprises one of a size of the graphical element or a perceived proximity of the graphical element to a viewer.

13. The method according to claim 11, wherein one or more graphical elements are representative of multiple items within the search pool and serving as a user control triggering expanded display of additional graphical elements each representative of a subset of the multiple items.

14. The method according to claim 11, wherein the graphical element is updated whenever the specified criteria are changed by either adding, deleting or modifying a search query element or updating a user profile.

15. The method according to claim 11, wherein the graphical element is updated whenever an item is added or deleted from the search pool.

16. A signal comprising:
a plurality of graphical elements representative of each available item within a search pool,
a graphical feature of each graphical element depending upon a relevance of the associated item to specified criteria,
wherein each graphical element is updated in response to any change to the specified criteria or the search pool.

17. The signal according to claim 16, wherein the graphical feature of each graphical element depending upon the relevance of the associated item to specified criteria further comprises one of a size of the graphical element or a perceived proximity of the graphical element to a viewer.

18. The signal according to claim 16, wherein one or more graphical elements are representative of multiple items within the search pool and serve as a user control triggering expanded display of additional graphical elements each representative of a subset of the multiple items.

19. The signal according to claim 16, wherein each graphical element is updated whenever the specified criteria are changed by either adding, deleting or modifying a search query element or updating a user profile.

20. The signal according to claim 16, wherein each graphical element is updated whenever an item is added or deleted from the search pool.
